(19) United States
(12) Patent Application Publication
(10) Pub. No.: US 2020/0104981 A1
(43) Pub. Date: Apr. 2, 2020

(54) IMAGE PROCESSING METHOD, IMAGE PROCESSING APPARATUS, IMAGING APPARATUS, AND STORAGE MEDIUM

(71) Applicant: CANON KABUSHIKI KAISHA, Tokyo (JP)

(72) Inventor: Akira Eguchi, Utsunomiya-shi (JP)

(21) Appl. No.: 16/701,865

(22) Filed: Dec. 3, 2019

Related U.S. Application Data
(63) Continuation of application No. PCT/JP2018/020261, filed on May 28, 2018.

(30) Foreign Application Priority Data
Jun. 9, 2017 (JP) 2017-113952
Mar. 8, 2018 (JP) 2018-042411

(51) Int. Cl. G06T 5/00; G06T 5/10; G06T 5/50

(52) U.S. Cl. CPC G06T 5/003; G06T 5/10; G06T 2207/20224; G06T 2207/20024; G06T 5/50

(57) ABSTRACT

An image processing method includes acquiring a plurality of coded data based on imaging of an object using a plurality of types of coding masks, calculating composite data based on the plurality of coded data by weighted averaging using complex coefficients, and calculating an object image by reconstruction processing based on the composite data and the plurality of types of coding masks. The reconstruction processing includes performing a deconvolution calculation for the composite data based on a transmittance distribution of the plurality of types of coding masks.

### CROSS-REFERENCE TO RELATED APPLICATIONS

This application is a Continuation of International Patent Application No. PCT/JP2018/020261, filed on May 28, 2018, which claims the benefit of Japanese Patent Applications Nos. 2017-113952, filed on Jun. 9, 2017, and 2018-042411, filed on Mar. 8, 2018, each of which is hereby incorporated by reference herein in their entirety.

### BACKGROUND OF THE INVENTION

### Field of the Invention

The present invention relates to an image processing method configured to reconstruct an object image through calculation processing based on coded data generated by imaging the object using a coding mask.

### Description of the Related Art

An imaging apparatus, such as a camera or a telescope, uses an optical element, such as a lens, to form an object image on the imaging plane of the image sensor, and acquires a luminance distribution as an image. Since the image formed on the imaging plane reproduces the luminance distribution of the object almost as it is, the imaging apparatus can acquire the object image without special postprocessing. However, in order to acquire an ideal image, it is necessary to use a highly designed and processed lens, and an imaging apparatus including such a lens becomes inevitably expensive.

U.S. Pat. No. 9,445,115 and Japanese Publication No. 2016-510910 propose a method for reconstructing an object image without using a lens for the cost reduction of an imaging apparatus. The above method disposes a coding mask having a special shape on a front side (object side) of an image sensor, and reconstructs the object image by solving an inverse problem on the computer from the acquired transmission image. As a method for solving the inverse problem, U.S. Pat. No. 9,445,115 discloses a method for decomposes a coding mask using the Toeplitz matrix and performs a reconstruction operation using the Wiener filter and the Landweber method. Japanese Publication No. 2016-510910 discloses a method using the Tikhonov regularization, a method using the compression detection, and the like.

Normally, there is a zero point in a frequency spectrum of the coding mask where the amplitude drops to nearly zero. Thus, in restoring the information in the frequency domain, the noise is amplified by the restoration and it is difficult to calculate a good image. Generally, in order to suppress the noise amplification, recovery processing is performed using the Wiener filter but the recovery processing is performed except the zero point, and thus the recovery effect cannot be substantially obtained in a region where the zero point exists. Therefore, the method of U.S. Pat. No. 9,445,115 has a frequency component in which a recovery effect cannot be obtained. The method of Japanese Publication No. 2016-510910 has a large calculation load for solving the optimization problem, and takes a long time to reconstruct the image.

### SUMMARY OF THE INVENTION

The present invention provides an image processing method, an image processing apparatus, an imaging apparatus, and a storage medium, each of which can quickly reconstruct an object image with high quality.

An image processing method according to one aspect of the present invention includes acquiring a plurality of coded data based on imaging of an object using a plurality of types of coding masks, calculating composite data based on the plurality of coded data by weighted averaging using complex coefficients, and calculating an object image by reconstruction processing based on the composite data and the plurality of types of coding masks. The reconstruction processing includes performing a deconvolution calculation for the composite data based on a transmittance distribution of the plurality of types of coding masks. A non-transitory computer-readable storage medium storing an image processing program as a computer program that causes a computer to execute the above image processing method also constitutes another aspect of the present invention.

An image processing apparatus corresponding to the image processing method, and an imaging apparatus that includes the imaging processing apparatus also constitute another aspect of the present invention.

Further features of the present invention will become apparent from the following description of exemplary embodiments with reference to the attached drawings.

### BRIEF DESCRIPTION OF THE DRAWINGS

FIG. 1 schematically illustrates an imaging apparatus having an image processing apparatus according to one embodiment of the present invention.

FIG. 2 illustrates a relationship between an object and coded data.

FIG. 3 is a flowchart illustrating an image processing method according to this embodiment.

FIG. 4 illustrates an object.

FIG. 5 illustrates a coding mask according to a first embodiment.

FIG. 6 illustrates coded data according to the first embodiment.

FIG. 7 illustrates a reconstructed image according to the first embodiment.

FIG. 8 illustrates a reconstructed image acquired by a conventional method.

FIG. 9 illustrates a coding mask according to a second embodiment.

FIG. 10 illustrates a reconstructed image according to the second embodiment.

FIG. 11 illustrates a reconstructed image acquired by a conventional method.

FIG. 12 illustrates a coding mask according to a third embodiment.

FIG. 13 illustrates a reconstructed image according to the third embodiment.

FIG. 14 illustrates a reconstructed image acquired by a conventional method.

FIG. 15 illustrates a coding mask according to a fourth embodiment.

FIG. 16 illustrates a reconstructed image according to the fourth embodiment.

FIG. 17 illustrates a reconstructed image acquired by a conventional method.

FIG. 18 illustrates an image processing method according to a sixth embodiment.

FIG. 19 illustrates a reconstructed image according to the sixth embodiment.

FIG. 20 is a sectional view of a spatial spectrum of a coding mask.

### DESCRIPTION OF THE EMBODIMENTS

Referring now to the accompanying drawings, a description will be given of embodiments according to the present invention. Corresponding elements in respective figures will be designated by the same reference numerals, and a duplicate description thereof will be omitted.

FIG. 1 schematically illustrates an imaging apparatus 100 having an image processing apparatus 104 according to one embodiment of the present invention. The imaging apparatus 100 includes a coding mask 101, an image sensor 102, a data storage apparatus 103, and an image processing apparatus 104.

Light emitted from an object 1 passes through the coding mask 101 and reaches the image sensor 102. The image sensor 102 acquires the light intensity distribution (coded data) coded by the coding mask 101. The data storage apparatus 103 stores the coded data acquired by the image sensor 102. The image processing apparatus 104 performs image processing corresponding to the mask shape for the coded data read from the data storage apparatus 103.

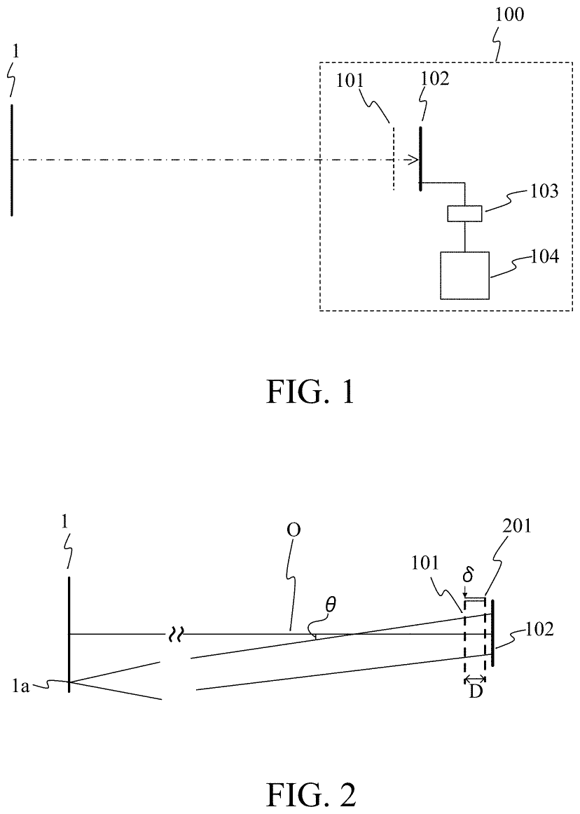

A description will now be given of an image processing method executed by the image processing apparatus 104. Referring now to FIG. 2, a description will be given of a principle of the present invention. FIG. 2 illustrates a relationship between the object 1 and the coded data.

The light emitted from a point on the object 1 almost uniformly illuminates the coding mask 101, and a shadow of the coding mask 101 is projected onto an imaging plane of the image sensor 102. The light emitted from a point 1a that is not a point on the optical axis O on the object 1 obliquely illuminates the coding mask 101. Therefore, on the imaging plane, a shadow 201 of the coding mask 101 is projected at a position shifted by a shift amount δ determined with respect to the coding mask 101 by an angle θ between the optical axis O and the light emitted from the object point 1a and a distance D between the coding mask 101 and the image sensor 102. The image sensor 102 acquires, as the coded data, a combination of projection images of the coding mask 101 formed by light emitted from each object point. If it is assumed that the luminance distribution of the object 1 is a function o(δ) of the shift amount δ, and a transmittance of the coding mask 101 is a function t(x) of a position coordinate x in the direction perpendicular to the optical axis O. The coded data i(x) acquired by the image sensor 102 can be expressed by the following expression (1).

$$\begin{matrix}i ( x ) = {\int }_{- ∞}^{∞} o ( δ ) t ( x - δ ) d δ \\ = o ( x ) * t ( x )\end{matrix} \qquad ( 1 )$$

Herein, * means a convolution. The image processing apparatus 104 calculates the luminance distribution o(δ) of the object 1 that satisfies the expression (1) from the transmittance t(x) and the coded data i(x) of the coding mask 101. However, this calculation is generally considered difficult. When both sides of the expression (1) are Fourier-transformed, the expression (1) is expressed by the following expression (2) by the convolution theorem.

I(ζ)=O(ζ)×T(ζ) (2)

I(ζ), O(ζ), and T(ζ) are Fourier transforms of the coded data i(x), the luminance distribution o(δ) of the object 1, and the transmittance t(x) of the coding mask 101, respectively, and represents a spatial frequency. From the expression (2), O(ζ) can be obtained by dividing I(ζ) by T(ζ). Since the frequency spectrum T of the coding mask generally has a zero point whose value becomes very small at a specific frequency, information in the frequency domain is excessively amplified or the noise is amplified by the division. Thus, the conventional method avoids the zero drop in the frequency domain using a Wiener filter or the like. However, use of the Wiener filter causes a frequency domain in which a recovery effect cannot be obtained, so that a sufficiently high-quality reproduced image cannot be acquired. In addition, a method using a repetitive calculation such as the Landweber method needs a very heavy load for the calculation.

The present invention uses a plurality of coded data in order to avoid such a problem. In order to use a plurality of coded data, it is necessary to prepare a plurality of types of coding masks. Now, in an example, two types of coding masks having a transmittance distribution are prepared: A first coding mask is represented by t₁(x)=(1+cos(2πζ₀x²))2, and a second coding mask is represented by t₂(x)=(1+sin(2πζ₀x²))/2. ζ₀ is a constant. The coded data acquired using the first coding mask and the second coding mask can be expressed by the following expressions (3) and (4), respectively.

i₁(x)=o(x)*(1+cos(2πζ₀x²))2 (3)

i₂(x)=o(x)*(1+sin(2πζ₀x²))/2 (4)

In the present invention, the image processing apparatus 104 calculates composite data iₘᵢₓ(x) by performing a weighted average represented by the following expression (5) for these coded data.

iₘᵢₓ(x)=i₁+j×i₂ (5)

“j” is an imaginary unit. The expression (5) can be rewritten into the following expression (6) by substituting the expressions (3) and (4).

iₘᵢₓ(x)=o(x)*exp(2πjζₒx²)/2+C₁ (6)

Cᵢ is a complex constant. The first term in the expression (6) is a convolution calculation between the luminance distribution of the object and the new complex function exp(2πjζ₀x²). The expression (6) is expressed by the following expression (7) by the convolution theorem by Fourier-transforming both sides except for the complex constant C₁.

Iₘᵢₓ(ζ)=O(ζ)×C₂exp(−πjζ²/2ζ₀) (7)

C₂ is a complex constant, and Iₘᵢₓ(ζ) is a Fourier transform of the composite data iₘᵢₓ(x). exp(−πjζ²/2ζ₀) is a function having an absolute value of 1 in all frequency domains or having no zero point. Hence, information in all frequency domains can be recovered by dividing the spectrum Iₘᵢₓ(ζ) of the composite data i ₘᵢₓ(x) by exp(−πjζ²2ζ₀) or by multiplying by an inverse filter in the frequency space. Finally, by inversely Fourier-transforming the frequency domain information, a high-quality object image (reconstructed image) can be acquired. The Fourier transform and inverse Fourier transform can be quickly executed by using FFT (fast Fourier transform), inverse FFT, or the like.

As described above, the above method can provide a reconstruction calculation using the inverse filter by a weighted average of a plurality of coded data according to the expression (5) and by generating composite data.

The above description uses a specific coding mask, but the present invention is not limited to this embodiment. To illustrate the generality of the present invention, the above discussion will be generalized. A description will now be given of an arbitrary complex function g(x) defined by the following expressions (8) and (9) using an arbitrary real variable function Φ(ζ).

G(ζ)=exp(jΦ(ζ)) (8)

g(x)=FT⁻¹[G(ζ)] (9)

Herein, FT means a Fourier transform, and FT¹ means an inverse Fourier transform. In the following description, G(ζ) is referred to as a complex function filter, and g(x) is referred to as a complex function mask. First, using the real part and the imaginary part of the complex function mask g(x), two types of coding masks are produced which have transmittance distributions represented by the following expressions (10) and (11).

t₁(x)=(1+Re[g(x)])/2 (10)

t₂(x)=(1+Im[g(x)])/2 (11)

By performing a weighted average using a complex coefficient similar to the expression (5) for the two coded data (coded data 1 and 2) obtained using these coding masks, the composite data iₘᵢₓ(x) is expressed by the following expression (12).

iₘᵢₓ(x)=o(x)*g(x)/2+C₃ (12)

C₃ is a complex constant. The first term of the expression (12) is a convolution calculation of the luminance distribution of the object and a complex function, as in the expression (6). The expression (12) is expressed by the following expression (13) by the convolution theorem when both sides are Fourier transformed except for the complex constant C₃.

I ₘᵢₓ(ζ)=O(ζ)×G(ζ)/2 (13)

Since G(ζ) has an absolute value of 1 in all frequency domains from the expression (8), the spectrum of the object in all frequency domains can be restored by dividing by G(ζ). Thus, the present invention is not limited to the case of the coding mask when the real variable function Φ(ζ) is specified as −πζ²/2ζ₀ as in the above example or is not limited to a specific coding mask. Therefore, the present invention can acquire a high-quality object image.

While this embodiment has discussed one dimension for the sake of simplicity, this embodiment can be easily extended to the two dimensions.

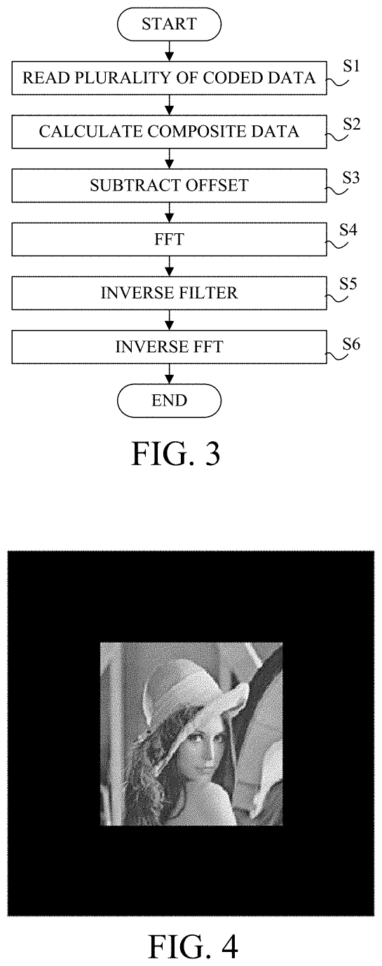

Referring now to FIG. 3, a description will be given of an image processing method executed by the image processing apparatus 104. FIG. 3 is a flowchart illustrating the image processing method according to this embodiment. The image processing method according to this embodiment is executed according to an image processing program that operates on software and hardware. For example, the image processing program may be stored in the image processing apparatus 104 or may be recorded on a non-transitory computer-readable storage medium. In this embodiment, the image processing apparatus 104 executes the image processing method, but a personal computer (“PC”) or a dedicated apparatus may execute the image processing method according to this embodiment as an image processing apparatus. Further, a circuit corresponding to the image processing program according to this embodiment may be provided, and the image processing method according to this embodiment may be executed by operating the circuit.

In the step S1, the image processing apparatus 104 acquires a plurality of coded data based on the imaging of the object 1 using a plurality of types of coding masks. In other words, the image processing apparatus 104 serves as an acquisition unit.

In the step S2, the image processing apparatus 104 calculates composite data based on the plurality of coded data acquired in the step S1 by the weighted average using the complex coefficient expressed by the expression (5). In other words, the image processing apparatus 104 serves as a calculation unit.

In the step S3, the image processing apparatus 104 subtracts the offset from the composite data calculated in the step S2.

In the step S4, the image processing apparatus 104 performs the FFT to calculate the converted (or transformed) data (spectrum data).

In the step S5, the image processing apparatus 104 multiplies the converted data by the inverse filter in a frequency space determined from the complex function filter G(ζ).

In the step S6, the image processing apparatus 104 reconstructs the image of the object 1 by performing the inverse FFT.

In this embodiment, the processing subsequent to the step S3 will be referred to as reconfiguration processing, and the processing from the step S4 to the step S6 will be referred to as the deconvolution calculation. In other words, the image processing apparatus 104 serves as a reconstruction unit.

By the above method, a high-quality object image can be quickly reconstructed from a plurality of coded data.

Each of the following embodiments will describe a reconstructed image acquired using the image illustrated in FIG. 4.

### First Embodiment

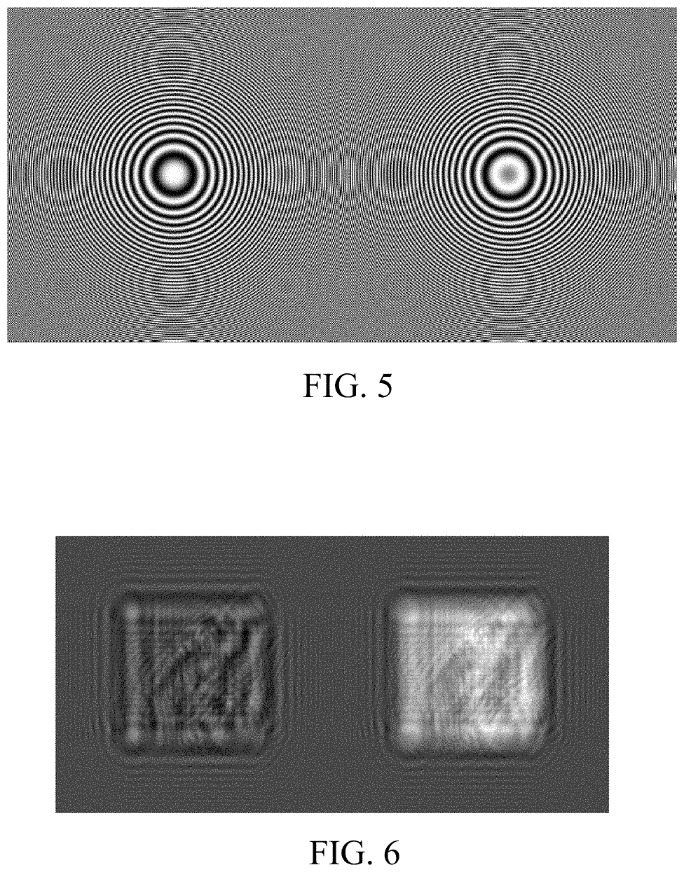

In this embodiment, the coding mask illustrated in FIG. 5 is used as the coding mask 101. The coding mask according to this embodiment has a concentric pattern. The coding mask according to this embodiment has a transmittance distribution represented by t₁(x)=(1+cos(2πζ₀(x²+y²)))/2 in the left region, and t₂(x)=(1+sin(2πζ₀(x²+y²)))/2 in the right region.

First, the image processing apparatus 104 reads the coded data illustrated in FIG. 6 generated using the coding mask illustrated in FIG. 5 from the data storage apparatus 103. The coded data illustrated in FIG. 6 is generated by a simulation using ζ₀=0.017 [1/pixel] and the sampling number of 300×600.

Next, the image processing apparatus 104 divides the coded data read from the data storage apparatus 103 into two or left and right regions, and treats each data as coded data 1 and 2, respectively. The image processing apparatus 104 may read the coded data 1 and 2 that are already divided and stored in the data storage apparatus 103.

Next, the image processing apparatus 104 calculates the composite data based on the coded data 1 and 2 by the weighted average represented by the expression (5). Next, the image processing apparatus 104 calculates spectral data by performing the FFT after subtracting the offset from the composite data.

Finally, the image processing apparatus 104 performs the inverse FFT after multiplying the spectrum data by the inverse of the complex function filter (exp(−πj(ζ²+η²)/2ζ₀) determined by the expression (8). Herein, η is a spatial frequency in the y direction.

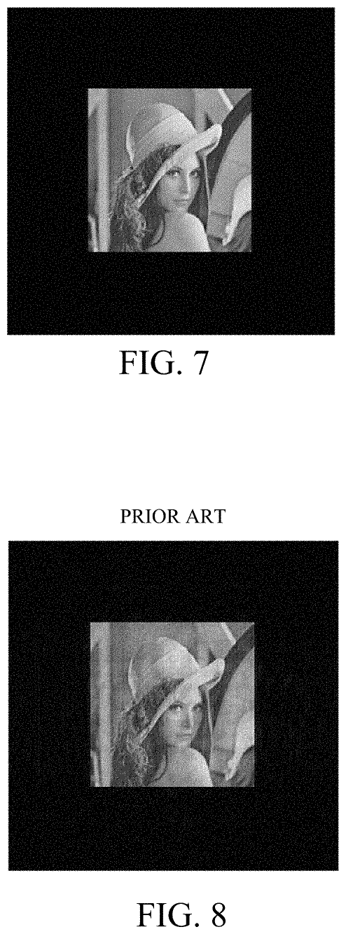

The image processing apparatus 104 can acquire the object image that reproduces the object well as illustrated in FIG. 7 by executing the image processing method according to this embodiment. FIG. 8 illustrates an object image reconstructed by the Wiener filter using only the coded data 1 and the calculation time equivalent to that of this embodiment. When FIGS. 7 and 8 are compared with each other, it can be seen that the image obtained by executing the image processing method according to this embodiment has a higher quality. When the PSNR that is one of the image evaluation indexes is calculated, the image acquired by executing the image processing method according to this embodiment shows 34.7, and the image acquired by executing the conventional method shows 26.8. The image quality thus quantitatively improves.

### Second Embodiment

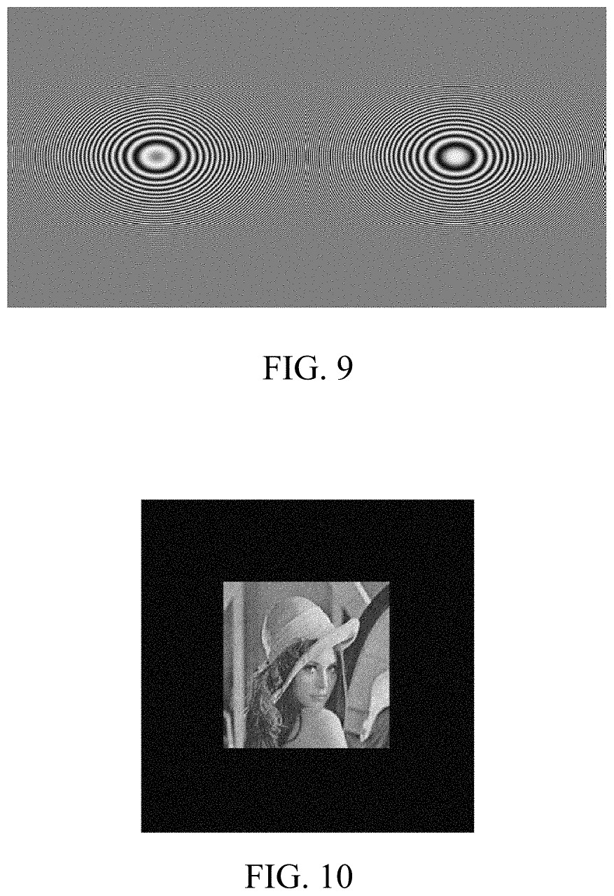

This embodiment uses a coding mask illustrated in FIG. 9 as the coding mask 101. This embodiment sets the real variable function Φ(ζ, η) to −π(ζ²+0.5η²)/2ζ₀, and uses a first coding mask having a transmittance distribution calculated with the expression (10) and a second coding mask having a transmittance distribution calculated with the expression (11). Since the real variable function Φ has an elliptical shape, the coding mask according to this embodiment has an elliptical shape.

Initially, the image processing apparatus 104 uses the first and second coding masks to generate coded data 1 and 2 corresponding to the first and second coding masks generated by the same simulation as that in the first embodiment.

Next, the image processing apparatus 104 calculates composite data based on the coded data 1 and 2 by the weighted average represented by the equation (5). Next, the image processing apparatus 104 calculates spectral data by performing the FFT after subtracting the offset from the composite data.

Finally, the image processing apparatus 104 performs the inverse FFT after multiplying the spectrum data by the inverse of the complex function filter determined by the expression (8).

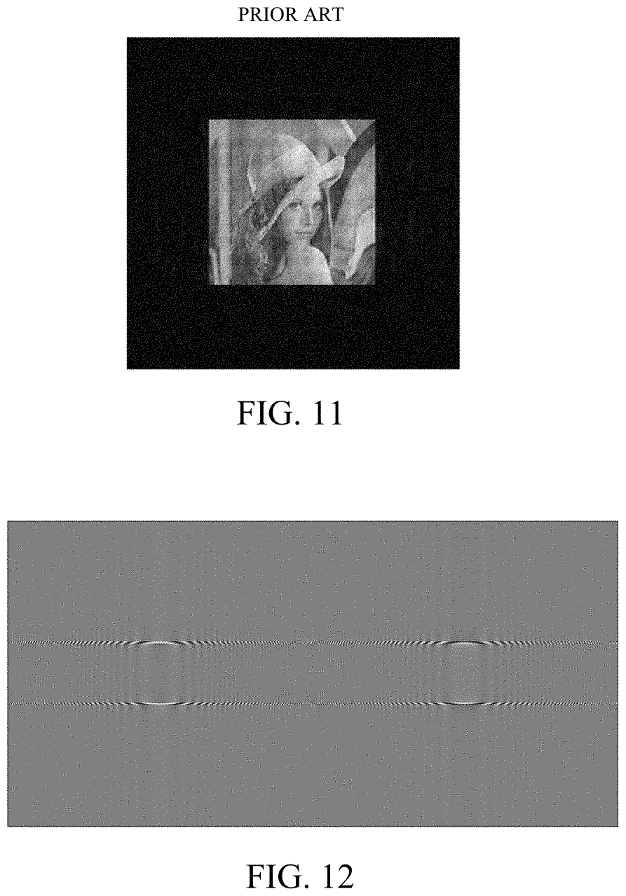

The image processing apparatus 104 can acquire an object image that reproduces the object well as illustrated in FIG. 10 by executing the image processing method according to this embodiment. FIG. 11 illustrates an object image reconstructed by the Wiener filter using only the coded data 1 and the calculation time equivalent to that of this embodiment. When FIGS. 10 and 11 are compared with each other, it can be seen that the image obtained by executing the image processing method according to this embodiment has a higher quality. When the PSNR is calculated, the image acquired by executing the image processing method according to this embodiment shows 26.2, the image acquired by executing the conventional method shows 22.6, and thus the image quality quantitatively improves.

### Third Embodiment

This embodiment uses a coding mask illustrated in FIG. 12 as the coding mask 101. This embodiment sets the real variable function Φ(ζ, η) to −π(ζ²+0.2|η|)/(2ζ₀), and uses a first encoding having a transmittance distribution calculated with the expression (10) and a second coding mask having a transmittance distribution calculated with the expression (11). Since the real variable function Φ has a linear function of the spatial frequency, the coding mask according to this embodiment has a substantially linear shape.

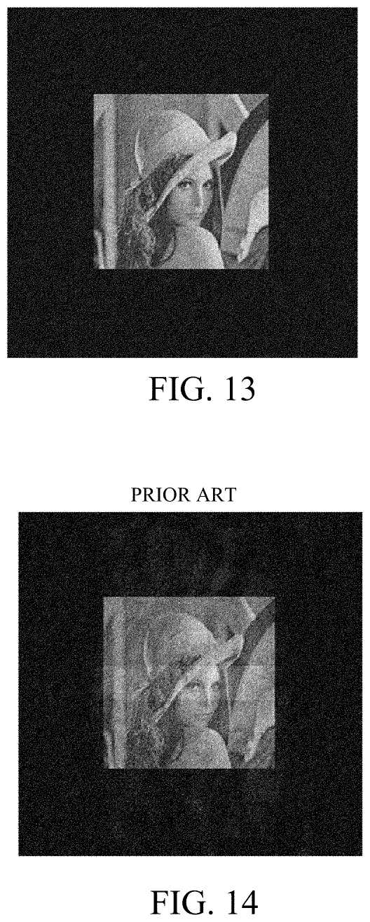

The image processing apparatus 104 can acquire an object image illustrated in FIG. 13 according to the flowchart of FIG. 3. FIG. 14 illustrates an object image reconstructed by the Wiener filter using only the coded data 1 and the calculation time equivalent to that of this embodiment. When FIGS. 13 and 14 are compared with each other, it can be seen that the image obtained by executing the image processing method according to this embodiment has a higher quality. When the PSNR is calculated, the image acquired by executing the image processing method of this embodiment shows 21.8, the image acquired by executing the conventional method shows 17.1, and thus the image quality quantitatively improves.

### Fourth Embodiment

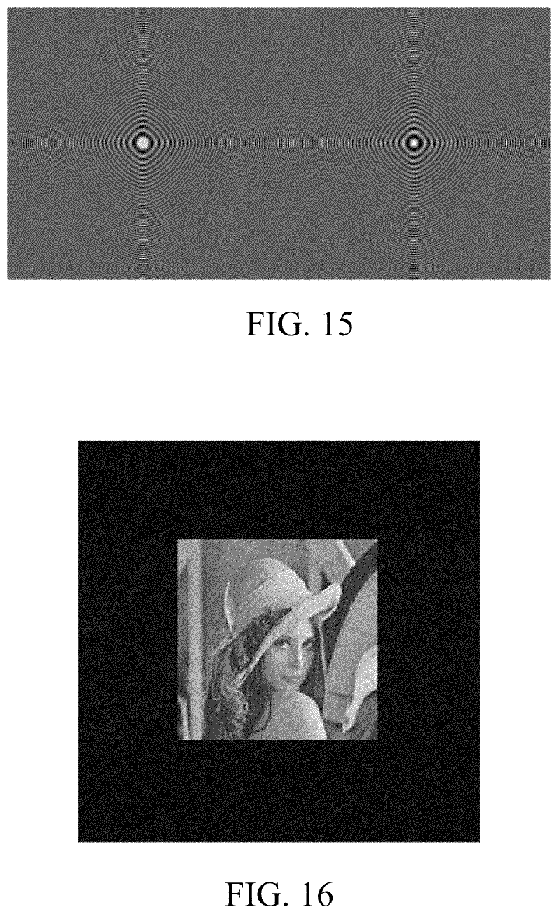

This embodiment uses a coding mask illustrated in FIG. 15 as the coding mask 101. This embodiment sets the real variable function Φ(ζ, η) to a cubic function represented by −π(|ζ|³+|η|³)/ζ₀, and uses a first coding mask having a transmittance distribution represented by the expression (10) and a second coding mask having a transmittance distribution represented by the expression (11). In this embodiment, the real variable function Φ(ζ, η) is a cubic function, but may be an n-th order function such as a quadratic function.

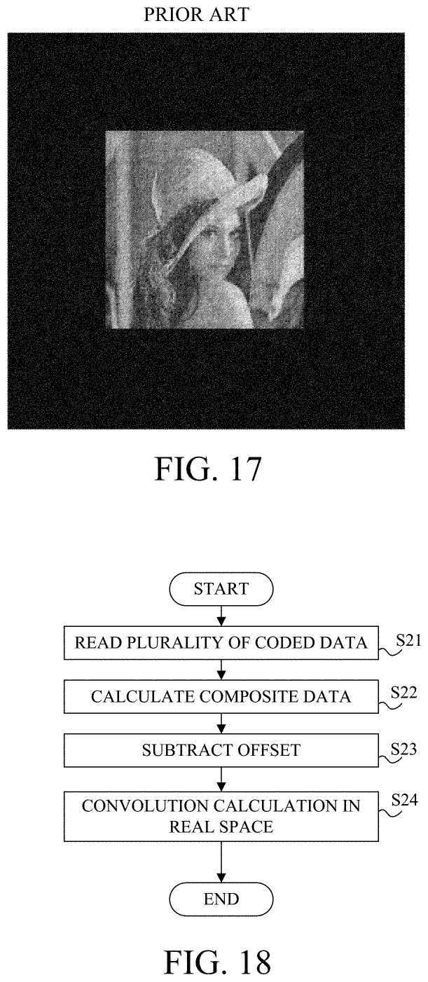

The image processing apparatus 104 can acquire an object image illustrated in FIG. 16 according to the flowchart of FIG. 3. FIG. 17 illustrates an object image reconstructed by the Wiener filter using only the coded data 1 and the calculation time equivalent to that of this embodiment. When FIGS. 16 and 17 are compared with each other, it can be seen that the image obtained by executing the image processing method according to this embodiment has a higher quality. When the PSNR is calculated, the image acquired by executing the image processing method of this embodiment shows 24.5, the image acquired by executing the conventional method shows 21.2, and thus the image quality quantitatively improves.

### Fifth Embodiment

The present invention can provide fast processing because it does not involve a repetitive calculation, but also can provide faster processing by analytically executing part of the calculation in advance.

This embodiment sets the real variable function Φ(ζ) to be −π²/2ζ₀. For simplicity purposes, the results are illustrated in one dimension. The composite data that has undergone the inverse filter in the frequency space is expressed as FT⁻¹└Iₘᵢₓ(ζ)/(C₂×exp(−πjζ²/2ζ₀))┘. The composite data that has undergome the inverse filter is expressed by the following expression (14) by the convolution theorem.

iₘᵢₓ(x)*FT⁻¹[1/(C₂×exp(−πjζ²/2ζ₀))]=iₘᵢₓ(x)*(C₂′×exp(−2πjζ₀x²))=∫_{-∞}^{∞}iₘᵢₓ(x′)C′₂e^{-2πjζ}^{x}^{²}e^{4πjζ}^{₀}^{xx′}e^{-2πjζ}^{_{x′}}^{²}dx′ (14)

Since the integration by multiplying exp(4πjζ₀xx′) is equivalent to the Fourier transform, this convolution calculation can be calculated by a single FFT. In order to numerically multiply the inverse filter in the frequency space, at least two FFTs are required to calculate the spectrum of the composite data and to performing the inverse Fourier transform for the spectrum multiplied by the filter. However, as illustrated in this embodiment, by performing analytically part of the calculation in advance, it is possible to reconstruct an image by the single FFT after multiplying the complex pattern, and the calculation becomes faster.

### Sixth Embodiment

The calculation of the luminance distribution o(x) of the object from the composite data i ₘᵢₓ(x) can be also executed only by the calculation in the real space. The following equation (15) is a modification of the expression (13).

O(ζ)=Iₘᵢₓ(ζ)/G(ζ)×2 (15)

The expression (15) is expressed by the following expression (16) by performing the inverse Fourier transform for both sides.

o(x)=ₘᵢₓ(x)*FT⁻¹[2/G(ζ) (16)

In the expression (16), FT⁻¹[2/G(ζ)] is an inverse filter in real space. It can be seen from the expression (16) that the luminance distribution of the object can be calculated by a convolution calculation of the composite data and the inverse filter in the real space. Since the inverse filter in the real space does not depend on the object, it can be calculated in advance. Therefore, in reconstructing an image, it is only necessary to execute a convolution calculation with the composite data.

FIG. 18 is a flowchart illustrating the image processing method according to this embodiment executed by the image processing apparatus 104.

In the step S21, the image processing apparatus 104 acquires a plurality of coded data based on imaging of the object 1 using a plurality of types of coding masks. In other words, the image processing apparatus 104 serves as an acquisition unit.

In the step S22, the image processing apparatus 104 calculates composite data based on the plurality of coded data acquired in the step S21, using a weighted average using a complex coefficient expressed by the expression (5). In other words, the image processing apparatus 104 serves as a calculation unit.

In the step S23, the image processing apparatus 104 subtracts the offset from the composite data calculated in the step S22.

In the step S24, the image processing apparatus 104 reconstructs an image of the object 1 by performing the convolution calculation (deconvolution calculation) between the composite data after the offset is subtracted in the step S23 and the inverse filter in the real space calculated in advance.

In this embodiment, the processing of the steps S23 and S24 will be referred to as reconfiguration processing. In other words, the image processing apparatus 104 serves as a reconstruction unit.

By the above method, a high-quality object image can be quickly reconstructed from a plurality of coded data.

This embodiment uses for the coding mask 101 the same coding mask illustrated in FIG. 5 as that of the first embodiment. The image processing apparatus 104 previously calculates an inverse filter in a real space corresponding to the coding mask.

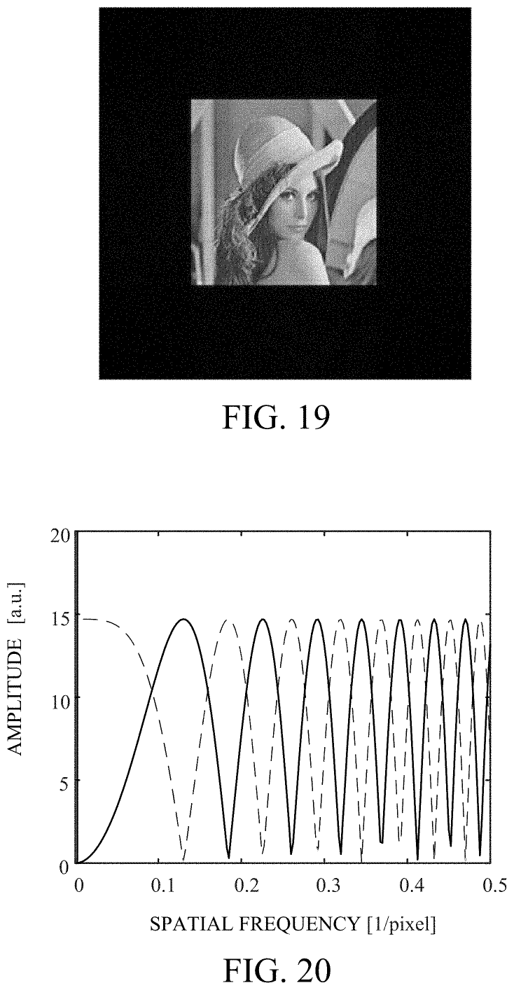

First, the image processing apparatus 104 uses the first and second coding masks to obtain the coded data 1 and 2 corresponding to the first and second coding masks generated by the same simulation as that in the first embodiment. Next, the image processing apparatus 104 calculates the composite data based on the coded data 1 and 2 by the weighted average represented by the expression (5). Next, the image processing apparatus 104 subtracts the offset from the composite data. Finally, the image processing apparatus 104 convolves the inverse filter in the real space, which has been calculated in advance, with the composite data from which the offset has been removed. FIG. 19 is an object image obtained by executing the image processing method according to this embodiment, and the object is well reproduced.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

Each embodiment has described the method of arranging two coding masks adjacent to each other, but the mask arrangement method is not limited to this embodiment. The effect of the present invention can be obtained as long as different coding masks are arranged at spatially different positions, or further as long as the coded data encoded by a plurality of different coding masks are acquired.

This embodiment has described, as a method for reconstructing the object image from the composite data, the method for dividing the composite data spectrum by the complex function filter G(ζ), but another method can be used for the reconstruction. For example, the composite data spectrum may be multiplied by a Wiener filter generated from the complex function filter G(ζ). If it is the calculation method which performs the deconvolution processing, the effect of this invention can be acquired.

This embodiment has referred to a place where the frequency spectrum value is zero as a zero point, but a place that should be treated as the zero point is not limited to the place where the frequency spectrum value is strictly zero. In particular, in processing data by a numerical calculation, the exact zero point often does not appear. However, even in this case, there is a region where the value of the frequency spectrum is smaller than another region, and this region is a place called the zero point. For example, points and regions where the value of the frequency spectrum is sufficiently small relative to the maximum value of the absolute value of the frequency spectrum obtained by the numerical calculation such as FFT may be treated as the zero point. More specifically, points and regions where the frequency spectrum value is 0.15 times or less of the maximum absolute value of the frequency spectrum may be treated as zero points. In addition, an offset due to the constant is added to the transmittance of the two coding masks defined by the expressions (10) and (11) in order to avoid the negative portion. In the case of such a coding mask, a point and a region where the value of the frequency spectrum is 0.15 times or less of the maximum absolute value in the region excluding the origin of the frequency spectrum may be treated as the zero point.

The present invention is particularly effective when the zero points of a plurality of types of coding masks do not overlap each other. For example, FIG. 20 is a sectional view of the spatial spectrum of the first and second coding masks when the real variable function Φ(ζ, η) is set to π(ζ²+η²)/0.034. A solid line represents a cross section of the spatial spectrum of the first coding mask, and a broken line represents a cross section of the spatial spectrum of the second coding mask. There is a zero point in the spatial spectrum of each coding mask, but the position of each zero point shifts. Since the zero points do not overlap each other, the weighted average can compensate for information that cannot be acquired with each mask, and consequently reconstruct a high-quality image.

This embodiment uses a complex function having an absolute value of 1 in all frequency domains as the complex function filter G(ζ) in the expression (8), but the present invention is not limited to this embodiment. For example, it may be a function represented by a(ζ, η)×exp(jΦ(ζ, η)) and having an absolute value with an attenuation or modulation. In particular, if the function a(ζ, η) representing the absolute value does not have a zero point, a high recovery effect can be obtained. Moreover, it is unnecessary that the zero point is strictly eliminated. If there is a zero point, the recovery processing may be performed using the Wiener filter or the like. In addition, the number of zero points or the size of the zero point area is smaller than a case where a single coded data is used due to the weighted average represented by the expression (5) and it is possible to obtain a reconstructed image with a higher quality than that with the single coded data.

This embodiment does not particularly limit the spatial frequency, but the minimum workable size is determined in the actually producible mask and thereby the maximum frequency that the coding mask can have is determined. Thus, strictly speaking, there can be no coding mask having no zero point in the spatial spectrum. However, when the present invention is implemented, the effect of the present invention can be obtained unless there is a zero point in the function a(ζ, η) within the target frequency domain. For example, there may be no zero point in a frequency domain smaller than the frequency determined from the reciprocal of the sampling pitch (sampling interval) Δ of the coded data expressed by the following expression (17).

ζₘₐₓ=½Δ (17)

This embodiment has described the method of generating the coding mask from the complex function mask g(x) using the expressions (10) and (11), but the present invention is not limited to this embodiment. For example, when the complex function mask g(x) has a wide amplitude, a coding mask may be generated using the expressions (10) and (11) after performing the normalization or the like. The constant added in the expressions (10) and (11) may be adjusted with a value different from 1. If each coding mask has a shape including the real part and the imaginary part of the complex function g(x), the effect of the present invention can be obtained.

Furthermore, each of the first and second coding masks does not need to have a shape that explicitly includes the real part and the imaginary part of the complex function g(x). The coding mask which includes new functions 1 and 2 produced by a weighted average, linear transformation, etc. from the real part and the imaginary part may be used. In this case, in generating the composite data, the complex data calculated from this weight may be multiplied and averaged.

This embodiment has described use of two types of coding masks, but the present invention is not limited to this embodiment. A new function may be generated by properly dividing the real part and the imaginary part of the complex function g(x), and three or more types of coding masks may be generated from it.

This embodiment has calculated the inverse filter in the frequency space and the real space using the complex function filter G(ζ) generated from the real variable function Φ(ζ), but the present invention is not limited to this embodiment. For example, the composite mask g′(x) may be calculated from the transmittance distribution of the coding mask by the weighted average using the complex coefficient, the composite spectrum G′(ζ) may be calculated from the composite mask g′(x) by the Fourier transform, and the inverse filter may be generated from the combined spectrum G′(ζ).

The present invention may use either the Fourier transform or the inverse Fourier transform in calculating the frequency spectrum or in calculating data in the real space from the frequency spectrum. All operations may have a consistent combination. The gist of the present invention does not change depending on the conversion method.

There are a variety of methods for calculating the offset C₃ of the composite data calculated by the expression (12). For example, the average value of the composite data may be determined as the offset C₃. The value of the peripheral area of the coded data may be determined as the offset C₃. The offset may be removed from the coded data before the image is combined. The offset at that time may use the average value of the image or the value of the peripheral area of the image.

The present invention can provide an image processing method, an image processing apparatus, an imaging apparatus, and an image processing program that can quickly reconstruct a high-quality object image.

What is claimed is:

1. An image processing method comprising:
acquiring a plurality of coded data based on imaging of an object using a plurality of types of coding masks;
calculating composite data based on the plurality of coded data by weighted averaging using complex coefficients; and
calculating an object image by reconstruction processing based on the composite data and the plurality of types of coding masks,
wherein the reconstruction processing includes performing a deconvolution calculation for the composite data based on a transmittance distribution of the plurality of types of coding masks.

2. The image processing method according to claim 1, wherein the deconvolution calculation uses an inverse filter in a frequency space calculated based on the transmittance distribution of the plurality of types of coding masks.

3. The image processing method according to claim 2, wherein the deconvolution calculation includes:
calculating converted data from the composite data by a Fourier transform;
multiplying the converted data by the inverse filter in the frequency space; and
performing an inverse Fourier transform.

4. The image processing method according to claim 2, wherein the inverse filter in the frequency space is calculated based on a composite spectrum calculated by a Fourier transform from a composite mask calculated by a weighted average using complex coefficients from the transmittance distribution of the plurality of types of coding masks.

5. The image processing method according to claim 1, wherein the deconvolution calculation uses an inverse filter in a real space calculated based on a transmittance distribution of the plurality of types of coding masks.

6. The image processing method according to claim 5, wherein the deconvolution calculation includes convolving the inverse filter in the real space with the composite data.

7. The image processing method according to claim 5, wherein the inverse filter in the real space is calculated based on a combined spectrum calculated by a Fourier transform from a combined mask calculated by a weighted average using a complex coefficient from the transmittance distribution of the plurality of types of coding masks.

8. The image processing method according to claim 1, wherein the reconstruction processing includes subtracting a constant from the plurality of coded data.

9. The image processing method according to claim 1, wherein the reconstruction processing includes subtracting a complex constant from the composite data.

10. The image processing method according to claim 8, wherein the constant is determined based on an average value of the plurality of coded data.

11. The image processing method according to claim 8, wherein the constant is determined based on a value of a peripheral region of the plurality of coded data.

12. The image processing method according to claim 1, wherein the transmittance distribution of the plurality of types of coding masks includes a first transmittance distribution represented by a weighted average of a plurality of functions and a second transmittance distribution represented by a weighted average of a plurality of functions different from that of the first transmittance distribution.

13. The image processing method according to claim 12, wherein a domain that is 0.15 times or less of a maximum value of a frequency spectrum of the first transmittance distribution and a domain that is 0.15 times or less of a maximum value of a frequency spectrum of the second transmittance distribution are different from each other.

14. The image processing method according to claim 12, wherein the complex coefficient is calculated based on a weight of the weighted average of a plurality of functions representing the first transmittance distribution and a weight of the weighted average of a plurality of functions representing the second transmittance distribution.

15. The image processing method according to claim 12, wherein the transmittance distribution of the plurality of types of coding masks is generated based on a complex function mask represented by a complex function.

16. The image processing method according to claim 15, wherein the first and second transmittance distributions are based on the complex function.

17. The image processing method according to claim 15, wherein the first and second transmittance distributions are represented by a weighted average of a real part and an imaginary part of the complex function,
wherein the complex function is represented by an inverse Fourier transform of a complex function filter,
wherein the deconvolution calculation includes:
calculating converted data from the composite data by a Fourier transform;
multiplying an inverse filter in a frequency space calculated based on the complex function filter; and
performing an inverse Fourier transform.

18. The image processing method according to claim 15, wherein the first and second transmittance distributions are represented by a weighted average of a real part and an imaginary part of the complex function,
wherein the complex function is represented by an inverse Fourier transform of the complex function filter, and
wherein the deconvolution calculation includes convolving an inverse filter in a real space calculated based on the complex function filter into the composite data.

19. The image processing method according to claim 17, wherein the complex function filter in the frequency space is expressed as a(ζ, η)×exp(jΦ(ζ, η)) where ζ and η are spatial frequencies in each direction of two dimensions, a(ζ, η) is a positive real variable function, and Φ(ζ, η) is a real variable function,
wherein the positive real variable function a(ζ, η) satisfies a conditional expression of a(ζ, η)≥0.15aₘₐₓ in a region that satisfies a conditional expression of (ζ²⁺η²)^{1/2}≤½Δ,
where Δ is a sampling interval of the coded data and aₘₐₓ is a maximum value of the positive real variable function a(ζ, η).

20. The image processing method according to claim 19, wherein the real variable function of Φ(ζ, η) includes at least one linear function of the spatial frequencies of ζ and η.

21. The image processing method according to claim 19, wherein the real variable function Φ(ζ, η) includes at least one cubic function of the spatial frequencies of ζ and η.

22. An image processing apparatus comprising:
an acquisition unit configured to acquire a plurality of coded data based on imaging of an object using a plurality of types of coding masks;
a calculation unit configured to calculate composite data based on the plurality of coded data by weighted averaging using complex coefficients; and
a reconstruction unit configured to calculate an object image by reconstruction processing based on the composite data and the plurality of types of coding masks,
wherein the reconstruction unit performs a deconvolution calculation for the composite data based on a transmittance distribution of the plurality of types of coding masks.

23. An imaging apparatus comprising:
an image sensor; and
the image processing apparatus according to claim 22.

24. A non-transitory computer-readable storage medium storing an image processing program as a computer program that causes a computer to execute the image processing method according to claim 1.
